(19) United States
(12) Patent Application Publication
(10) Pub. No.: US 2012/0308453 A1
(43) Pub. Date: Dec. 6, 2012

(54) TREATMENT EQUIPMENT OF VOC GASES

(75) Inventors: Reijo Lylykangas, Vihtavuori (FI); Janne Salmi, Jyvaskyla (FI)

(73) Assignee: FORMIA EMISSIONS CONTROL OY, Saynatsalo (FI)

(21) Appl. No.: 13/513,635

(22) PCT Filed: Dec. 3, 2010
(86) PCT No.: PCT/FI10/50995

§ 371 Date: Aug. 20, 2012

(30) Foreign Application Priority Data
Dec. 4, 2009 (FI) 20096286

(51) Int. Cl. B21D 51/16; B01D 53/44; B01D 53/86

(52) U.S. Cl. 423/210; 137/15.01; 422/170

(57) ABSTRACT

A method of manufacturing treatment equipment (1) of VOC gases, the treatment equipment manufactured by this method and the use of such treatment equipment. In the manufacturing method, the treatment equipment (1) has attached thereto at least one gas distributor portion (5) and at least two gas distributing valves (5V) for alternately distributing the gas to be supplied to regenerative heat exchangers (2H, 3H), and the gas distributor portion (5) has further attached thereto at least one by-pass portion (7) that includes at least one by-pass control valve (7V), and the gas removal portion (6) has attached thereto an exhaust control valve (6V) for controlling the gas removal for directing the gas flow to the removal portion (6) and/or the by-pass portion (7), and the by-pass portion (7) and/or the removal portion (6) have attached thereto the post-exhaust catalyser (8) of VOC gases.

### BACKGROUND ART

The invention relates to a method of manufacturing equipment for treating volatile organic solvents (VOC gases). The invention also relates to the treatment equipment manufactured by this method and the use of such treatment equipment.

Solvent emissions in the EU are regulated by legislation that is based on the VOC directive EY1999/13. The directive includes the BAT principle (Best Available Technology), which obliges authorities to use stricter standards than what the directive prescribes if reliable technology at a reasonable price is commercially available for achieving the standards.

The directive prescribes standards for industrial solvent emissions (VOC), which are specific for each industrial field and the amounts of emissions, and which vary within 50-150 mg C/Nm³. Because of the development of the emission reduction technology, the authorities have recently set stricter limit values, often 20 mg C/Nm³. The goal of the EU is to further reduce the VOC emissions by 50%.

The U.S. has held state-specific emission standards for a long time. Often, percentage goals are set for the emission reduction. In Asia and South America, the VOC legislation is also gradually becoming stricter and a market of VOC oxidizers has sprung up.

There are several means to reduce VOC emissions. Water-dilutable paints and lacquers or those containing lesser amounts of solvents can be used, VOC gases can be burnt thermally or catalytically, they can be destroyed biologically, they can be recirculated, etc. A general trend is toward lower contents in emissions. This means that it is difficult to burn the solvents, because they do not contain enough energy to heat the solvent-containing gas flow to the combustion temperature. Support energy is needed, which may increase the costs considerably. On the other hand, irrespective of its form, the support energy produces more CO2 emissions.

The technique most generally used is thermal combustion, followed by catalytic oxidation. Both of them can use a recuperative or regenerative heat exchanger to increase the temperature of the gas coming to the oxidizer. At its best, the efficiency of the recuperative heat exchanger is 80% and that of the regenerative heat exchanger as high as 95%.

The most important difference between catalytic and thermal combustion is the firing temperature, which in thermal combustion is about 800° C. and in catalytic combustion about 300° C. This means that thermal combustion requires nearly three times more energy for heating the gas flow than catalytic combustion. The solvent content, which in thermal combustion is enough to produce the energy needed for the combustion is 1.5-3 g/Nm³. In catalytic combustion, the corresponding content is 0.5-1.0 g/Nm³. This content is called the autothermal point (ATP). Therefore, regenerative thermal oxidizers (RTO) are being converted into catalytic oxidizers (RCO) by simply placing a catalyser on top of the heat exchanger. In that case, the firing temperature can be reduced by about 500° C. Then, the ATP and also the need for supporting energy decrease.

A weakness of regenerative oxidizers is that the direction of the gas flow must be reversed between two charger/pre-heating heat exchanger units (beds). During a reversal, a small amount of unrefined gas then enters the exhaust pipe, reducing the efficiency of the oxidizer. A two-bed thermal oxidizer achieves an efficiency of about 95-96%. Because of its smaller size, waste of the reversal in the catalytic oxidizer is lower; therefore, the efficiency is higher, generally at least 98%. One solution in thermal combustion is often a third bed, by means of which an efficiency of as high as 99% can be achieved. But then, the third bed increases the costs of the oxidizer by about 30%. Instead of the third bed, it has been proposed to use various storage containers for eliminating the emissions during reversals.

### DESCRIPTION OF THE INVENTION

A manufacturing method of the treatment equipment of VOC gases has now been invented, enabling a considerable increase in the efficiency of the equipment by means of a technically simple implementation. The invention also relates to the equipment manufactured by this method and the use of such equipment.

To achieve this object, the invention is characterized in facts, which are described in the independent claims. The other claims describe some preferred embodiments of the invention. According to the invention, the treatment equipment of VOC gases is manufactured by the method according to any of the claims.

In the method according to the invention, the treatment equipment comprises at least one gas supply portion, at least one exhaust catalyser of VOC gases, and at least one gas removal portion. The treatment equipment has attached thereto at least two regenerative heat exchangers, at least one gas distributor portion, and at least one gas distributing valve for alternately delivering the gas to be supplied to the regenerative heat exchangers; the gas distributor portion has further attached thereto at least one by-pass portion that comprises at least one by-pass control valve; the gas removal portion has attached thereto an exhaust control valve for controlling the gas removal for directing the gas flow to the removal portion and/or the by-pass portion; and the by-pass portion and/or the removal portion have attached thereto the post-exhaust catalyser of VOC gases.

The novel technique now invented improves the efficiency of purification of the oxidizer, reduces costs and improves the serviceability of the equipment. In addition, the invention can be used in existing thermal and catalytic oxidizers.

For example, the invention can be used in the two-bed catalytic VOC oxidizers described in the EP application EP07122712.8 and the Finnish utility patent F18492, wherein the beds are built within each other.

According to an object of the invention, the treatment equipment has attached thereto at least two gas distributing valves for alternately distributing the gas to be supplied to the regenerative heat exchangers. This diversifies the possibilities to control and contributes to improving the efficiency of the equipment, reducing the amount of gas flowing past the catalysers in connection with reversals, and compared with the use of one gas distributing valve, the gas distributor portion becomes even simpler.

According to an object of the invention, the gas distributing valves are connected to the gas distributor portion. This solution renders the equipment compact, and technically and economically advantageous.

According to an object of the invention, the gas distributor portion comprises one or more connecting parts for directing the gas flow between the regenerative heat exchangers. This improves the possibilities to control the equipment, and its technical functioning.

According to an object of the invention, the gas treatment equipment further has gas heating equipment attached thereto for heating the gas to be treated, for example, during start-up. This solution is capable of enhancing the operation of the equipment, also enabling, for example, the treatment of rather poor gases.

According to an object of the invention, separate post-exhaust catalysers of VOC gases are attached to the by-pass portion and the removal portion. This further enhances the operation of the equipment also in the event of disturbances and during reversals.

According to an object of the invention, the post-exhaust catalyser in the by-pass portion of gas is installed in front of the by-pass control valve with respect to the direction of the gas flow. This has an essential advantage, for example, in applications, where the temperature of the post-exhaust catalyser of the equipment would otherwise be too low or separate heating would be required. In this application, the post-exhaust catalyser is always in working order. In catalytic oxidizers, a more preferable position is before the hot by-pass valve.

According to an object of the invention, the post-exhaust catalyser in the gas by-pass portion is installed after the by-pass control valve, and/or in the removal portion, after the exhaust control valve with respect to the direction of the gas flow. This is of advantage, for example, in applications where the post-exhaust catalyser would otherwise heat up to an excessively high temperature, or it would be necessary to separately cool the gas. In thermal oxidizers, the catalyser is preferably placed after the hot by-pass valve, as the temperature in the combustion chamber can increase to over 800° C. for long periods, which may weaken the activity of the catalyser.

According to an object of the invention, the post-exhaust catalyser of gases is a ceramic or metal-core catalyser and it contains noble metals, base metal oxides and/or other catalytic compounds. For example, noble metals are active and become activated even at low temperatures, whereby it is especially preferable to use them in specific applications.

According to an application of the invention, the exhaust catalyser is installed between two regenerative heat exchangers. This solution provides a solution that is technically very simple and also economic. A sequential structure can preferably be made using, for example, finished fittings and quick couplings for fastening the same. Such a structure can be quickly assembled or disassembled. The heat exchanger cells piled in the reactor and the catalyser coil are also easy to lift out of the pipe. In the heat exchanger and the catalyser, the mixing structure described in previous applications can be used.

According to an object of the invention, the gas distributing valve is a bidirectional disc valve that comprises flexible sealing edges for sealing the valve in two directions. The equipment preferably comprises two such disc valves that carry out the reversal, reversing the flow direction from the inner periphery to the outer periphery by one linear motion. The through hole of the transmission of the linear motion is easy to seal hermetically. The valve disc is, for example, a flexible disc placed between two support plates that adapts itself well to the shape of the sealing face and effectively seals the flow-through hole. The flow-through hole does not require a straight machined sealing face, but a hole that is cut to the disc by a laser, for example, is well-suited to the purpose. The actuator is preferably an air engine that is placed outside the reactor. In this way, it is easy to maintain.

According to an object of the invention, the post-exhaust catalyser and by-pass portion are first fitted in the treatment equipment of VOC gases. This provides the advantage that the technical and economic design and manufacture of the equipment can be carried out as cost-effectively as possible.

According to an object of the invention, the post-exhaust catalyser and by-pass portion are retrofitted in treatment equipment of VOC gases that is previously used. This solution provides a substantial, very advantageous enhancement in the existing treatment equipment both technically and economically. According to an object of the invention, the exhaust catalyser of VOC gases and the post-exhaust catalyser are installed in treatment equipment that also comprises or has fitted therein a thermal exhaust burner of VOC gases. This solution provides a substantial enhancement in the performance of the treatment plant compared with one that comprises a thermal exhaust burner only.

According to an object of the invention, during the reversal of the gas flow direction of the regenerative heat exchangers, gas is directed from the gas distributor portion through the by-pass control valve and/or from the removal portion through the exhaust control valve to the post-exhaust catalyser.

By means of the solution according to the present invention, nearly all of the emissions during reversals can be eliminated. The invention comprises a catalyser that is installed in a hot by-pass channel that is made for the elimination of excess heating or an exhaust gas pipe thereafter, and a check valve that is placed in the exhaust pipe. The solution functions as follows: Before a reversal, the valve of the hot by-pass channel is opened and immediately afterwards the valve of the exhaust pipe is closed. After this, the flow direction is reversed by valves that are developed for them and integrated into the oxidizer. Then, the normal condition is restored in a reversed order by first opening the exhaust pipe valve and closing the hot by-pass.

The procedure described above ensures that the gas constantly travels either through the main catalyser or the catalyser in the hot by-pass channel and is thereby effectively purified. The post-exhaust catalyser is preferably placed in the channel that is in direct contact with the hot space above the catalysers. This ensures that also the post-catalyser is constantly at the operating temperature. Noble metal catalysers are preferably used, enduring temperatures of up to 800° C. without the power of the catalyser weakening.

The solution according to the invention can also be retrofitted to all existing two-bed catalytic and thermal VOC oxidizers, and it can be used to improve the performance of the oxidizer in the manner described above.

According to an object of the invention, the regenerative heat exchangers and the exhaust catalyser(s) are arranged in series. This solution may be a suitable alternative, when low-capacity oxidizers are made (preferably 100-2000 Nm³/h). In that case, the heat exchanger coils and the catalyser can be packed in series in the same pipe/channel of the gas distributor portion. Gas is directed alternately inside either end of the reactor portion. The reversing valves preferably have structures similar to the disc valves described above.

### SPECIAL DESCRIPTION OF THE INVENTION

In the following, some applications of the invention are described in detail with reference to the appended drawings.

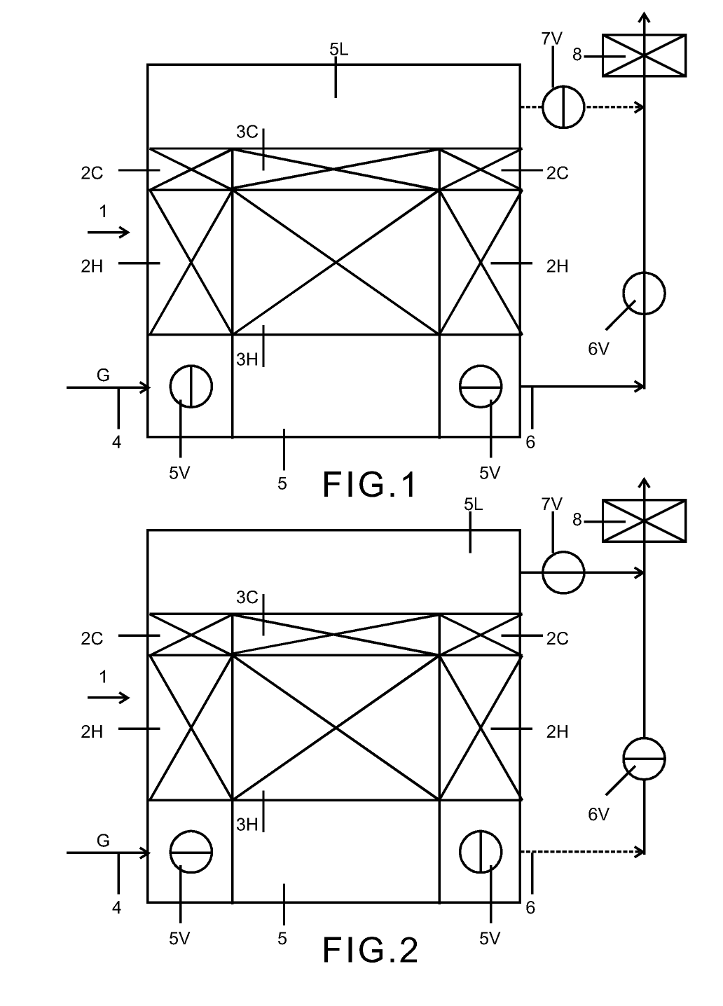

FIG. 1 shows treatment equipment that comprises two gas distributing valves.

FIG. 2 shows the treatment equipment of FIG. 1 with different adjustments of valves.

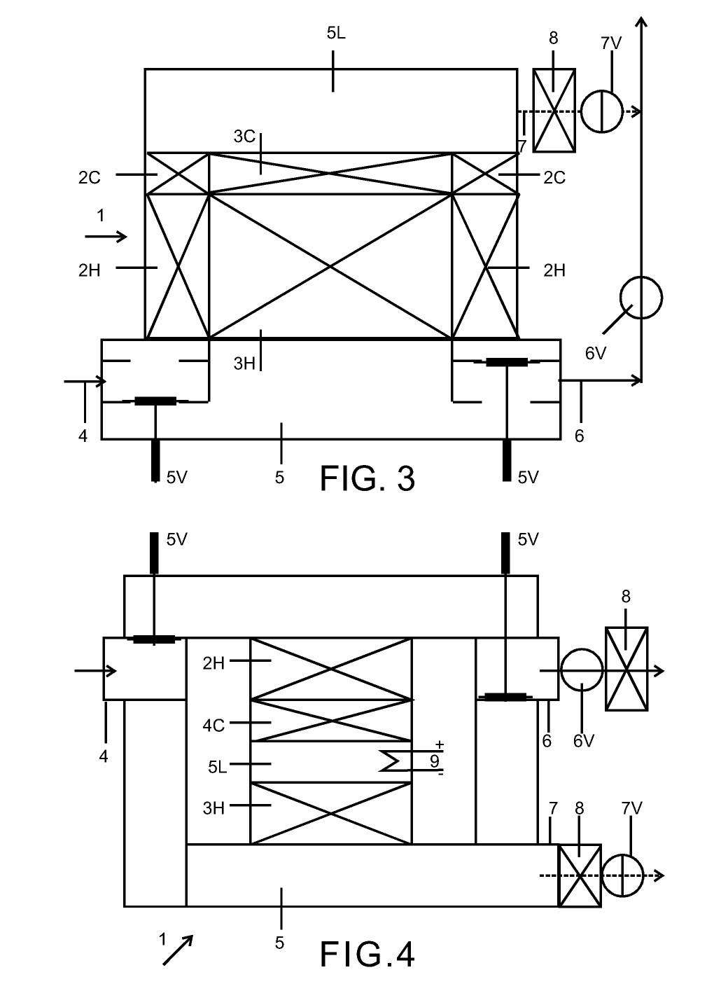

FIG. 3 shows treatment equipment that comprises bidirectional disc valves.

FIG. 4 shows treatment equipment that comprises sequential heat exchangers.

In FIGS. 1 and 2, the treatment equipment 1 comprises a gas supply portion 4 and a gas removal portion 6 and, in nested compartments, two regenerative heat exchangers 2H, 3H, and two exhaust catalysers 2C, 3C of VOC gases. The treatment equipment 1 comprises two gas distributor portions 5 and two gas distributing valves 5V for alternately distributing the gas to be supplied to the regenerative heat exchangers 2H, 3H, and the gas distributor portion 5 comprises a connecting part 5L for directing the gas flow between the regenerative heat exchangers 2H, 3H. The connecting part 5L has further attached thereto one by-pass portion 7 that comprises one by-pass control valve 7V, and the gas removal portion 6 has attached thereto an exhaust control valve 6V for directing the gas flow either to the removal portion 6 or the by-pass portion 7. The by-pass portion 7 is attached to the removal portion 6, to which the post-exhaust catalyser 8 of VOC gases is further attached. During the reversal of the gas flow direction that is implemented by the gas distributing valves 5V, gas is directed from the connecting part 5L of the gas distributor portion 5 through the by-pass control valve 7V to the post-exhaust catalyser 8. After the reversal, the gas that travelled through the exhaust catalysers 2C, 3C is again removed through the removal portion 6 to the post-exhaust catalyser 8 by opening the exhaust control valve 6V.

In FIG. 3, the treatment equipment 1 comprises a gas supply portion 4 and a gas removal portion 6 and, in nested compartments, two regenerative heat exchangers 2H, 3H, and two exhaust catalysers 2C, 3C of VOC gases. The treatment equipment 1 comprises two gas distributor portions 5 and two gas distributing valves 5V for alternately distributing the gas to be supplied to the regenerative heat exchangers 2H, 3H. The gas distributing valves 5V are bidirectional disc valves that comprise flexible sealing edges for sealing the valve in two directions. The gas distributor portion 5 comprises a connecting part 5L for directing the gas flow between the regenerative heat exchangers 2H, 3H. The by-pass portion 7 is attached to the gas distributor portion 5, comprising the post-exhaust catalyser 8 of VOC gases directly connected to the connecting part 5L. The by-pass portion 7 further comprises a by-pass control valve 7V, and the gas removal portion 6 comprises an exhaust control valve 6V for directing the gas flow either to the removal portion 6 or the by-pass portion 7. The by-pass portion 7 is further attached to the removal portion 6. During the reversal of the gas flow direction that is implemented by the gas distributing valves 5V, gas is directed from the connecting part 5L of the gas distributor portion 5 through the post-exhaust catalyser 8 and the by-pass control valve 7V to the removal portion 6. After the reversal, the gas that travelled through the exhaust catalysers 2C, 3C is again removed through the removal portion 6 by opening the exhaust control valve 6V and closing the by-pass control valve 7V.

In FIG. 4, the treatment equipment 1 comprises a gas supply portion 4, two regenerative heat exchangers 2H, 3H, one exhaust catalyser 4C of VOC gases, and a gas removal portion 6. The treatment equipment 1 comprises two gas distributor portions 5 and two gas distributing valves 5V for alternately distributing the gas to be supplied to the regenerative heat exchangers 2H, 3H. The gas distributor portion 5 comprises a connecting part 5L for directing the gas flow between the regenerative heat exchangers 2H, 3H. In this application, the exhaust catalyser is placed in the connecting part 5L that also comprises a heating device 9 for further heating the gas, for example, during start-up. The gas distributing valves 5V are bidirectional disc valves that comprise flexible sealing edges for sealing the valve in two directions. The by-pass portion 7 is attached to the gas distributor portion 5, comprising the post-exhaust catalyser 8 of VOC gases and the by-pass control valve 7V. The gas removal portion 6 comprises an exhaust control valve 6V and the post-exhaust catalyser 8 of VOC gases. During the reversal of the gas flow direction implemented by the gas distributing valves 5V, gas is directed to the post-exhaust catalyser 8 of the by-pass portion 7 by opening the by-pass control valve 7V and closing the exhaust control valve 6V. After the reversal, the gas that travelled through the exhaust catalyser 4C is again directed to the post-exhaust catalyser 8 of the removal portion 6, in turn, by opening the exhaust control valve 6V and closing the by-pass control valve 7V.

1-16. (canceled)

17. A method for manufacturing treatment equipment (1) of VOC gases, the treatment equipment (1) comprising at least one gas supply portion (4), at least one exhaust catalyser (2C, 3C, 4C) of VOC gases, and at least one gas removal portion (6), wherein
the treatment equipment (1) has attached thereto at least two regenerative heat exchangers (2H, 3H), at least one gas distributor portion (5), and at least two gas distributing valves (5V) for alternately distributing gas to be supplied to said regenerative heat exchangers (2H, 3H); and
said gas distributor portion (5) has further attached thereto at least one by-pass portion (7) that comprises at least one by-pass control valve (7V), and said gas removal portion (6) has attached thereto an exhaust control valve (6V) for directing the gas flow either to said removal portion (6) or to said by-pass portion (7); and
a post-exhaust catalyser (8) of VOC gases is attached to said by-pass portion (7) and/or said removal portion (6).

18. A method according to claim 17, wherein at least two regenerative heat exchangers (2H, 3H) are installed within each other or one upon the other.

19. A method according to claim 17, wherein said gas distributing valves (5V) are attached to said gas distributor portion (5).

20. A method according to claim 17, wherein said gas distributor portion (5) comprises one or more connecting parts (5L) for directing the gas flow between said regenerative heat exchangers (2H, 3H).

21. A method according to claim 17, wherein the gas treatment equipment (1) has further attached thereto a gas heating device (9) for heating the gas to be treated, for example, during start-up.

22. A method according to claim 17, wherein separate post-exhaust catalysers (8) of VOC gases are attached to said by-pass portion (7) and to said removal portion (6).

23. A method according to claim 17, wherein said post-exhaust catalyser (8) in said gas by-pass portion (7) is installed in front of said by-pass control valve (7V) with respect to the direction of the gas flow.

24. A method according to claim 17, wherein said post-exhaust catalyser (8) in said gas by-pass portion (7) is installed after said by-pass control valve (7V) and/or in said removal portion (6) after said exhaust control valve (6V) with respect to the direction of the gas flow.

25. A method according to claim 17, wherein said post-exhaust catalyser (8) of gases is a ceramic or metal-core catalyser and it contains noble metals, base metal oxides and/or other catalytic compounds.

26. A method according to claim 17, wherein said exhaust catalyser (2C, 3C, 4C) is installed between two regenerative heat exchangers (2H, 3H).

27. A method according to claim 17, wherein said gas distributing valves (5V) are a bidirectional disc valve that comprises flexible sealing edges for sealing the valve in two directions.

28. A method according to claim 17, wherein said post-exhaust catalyser (8) and said by-pass portion (7) are first fitted in the treatment equipment (1) of VOC gases.

29. A method according to claim 17, wherein said post-exhaust catalyser (8) and said by-pass portion (7) are retrofitted in treatment equipment (1) of VOC gases that has been in operation previously.

30. A method according to claim 17, wherein said exhaust catalyser (2C, 3C, 4C) of VOC gases and said post-exhaust catalyser (8) are installed in treatment equipment, which comprises or in which a thermal exhaust burner of VOC gases is also installed.

31. A treatment equipment (1) of VOC gases, comprising at least one gas supply portion (4), at least one exhaust catalyser (2C, 3C, 4C) of VOC gases, and at least one gas removal portion (6), wherein
the treatment equipment (1) has been attached thereto at least two regenerative heat exchangers (2H, 3H), at least one gas distributor portion (5), and at least two gas distributing valves (5V) for alternately distributing gas to be supplied to said regenerative heat exchangers (2H, 3H); and
said gas distributor portion (5) has been further attached thereto at least one by-pass portion (7) that comprises at least one by-pass control valve (7V), and said gas removal portion (6) has attached thereto an exhaust control valve (6V) for directing the gas flow either to said removal portion (6) or to said by-pass portion (7); and
a post-exhaust catalyser (8) of VOC gases has been attached to said by-pass portion (7) and/or said removal portion (6).

32. A method of using the treatment equipment (1) of VOC gases according to claim 31, wherein during the reversal of the gas flow direction of said regenerative heat exchangers (2H, 3H), gas is directed from said gas distributor portion (5) through said by-pass control valve (7V) and/or from said removal portion (6) through said exhaust control valve (6V) to said post-exhaust catalyser (8).
